(19) United States
(12) Patent Application Publication
(10) Pub. No.: US 2025/0250710 A1
(43) Pub. Date: Aug. 7, 2025

(54) INTERFACIAL MATERIALS AND METHODS OF MAKING AND USE THEREOF

(71) Applicant: Temple University-Of The Commonwealth System of Higher Education, Philadelphia, PA (US)

(72) Inventors: Long Zhu, Philadelphia, PA (US); Fei Ren, Chadds Ford, PA (US)

(21) Appl. No.: 19/024,956

(22) Filed: Jan. 16, 2025

Related U.S. Application Data
(60) Provisional application No. 63/622,139, filed on Jan. 18, 2024.

(51) Int. Cl. C25D 5/02; H01B 1/02; H01B 5/00

(52) U.S. Cl. CPC C25D 5/022; H01B 1/02; H01B 5/00

(57) ABSTRACT

The present invention provides a method of making an interfacial material, comprising the steps of: providing a double-sided substrate; adhering a template to at least one side of the double-sided substrate to provide at least one templated side of the double-sided substrate; exposing the double-sided substrate to a solution comprising a metal ion; and reducing the metal ion to form a metal, thereby bonding the at least one metal to at least one templated side of the double-sided substrate in a controlled geometry, and materials and devices thereof.

### CROSS-REFERENCE TO RELATED APPLICATIONS

This application claims priority to U.S. Provisional Patent Application Ser. No. 63/622,139, filed Jan. 18, 2024, the entire contents of which are incorporated herein by reference.

### BACKGROUND OF THE INVENTION

Thermal management is crucial for many applications, particularly in the semiconductor industry. The transportation of heat in electronic devices is primarily influenced by interfaces (Cahill et al., 2003, Journal of Applied Physics, 93, 793). Interface resistance or thermal contact resistance (TCR) accounts for over half of the total thermal resistance, which often hampers device performance and poses challenges to electronics' thermal management (Gong et al., 2018, Nano Letters, 18, 3586). For two contacting surfaces, the effective contact area or real contact area for heat conduction is only a small portion of the apparent contact area due to irregular asperities and microscopic surface roughness (Feng et al., 2013, Applied Physics Letters, 102, 093105). Therefore, thermal interface materials (TIMs) are sometimes used to accommodate microscopically rough surfaces in contact. TIMs can increase the real contact area and enhance heat transfer, thereby reducing temperature rise and preventing thermal-related breakdown of devices (Hansson et al., 2018, International Materials Reviews, 63, 22). Ideal TIMs should possess high thermal conductivity to improve interface heat transfer, as well as good mechanical compliance to accommodate the roughness of mating surfaces and manage thermal stress caused by surface strain mismatch (Barako et al., 2017, ACS Applied Materials & Interfaces, 9, 42067; Lin et al., 2021, Advanced Materials Interfaces, 8, 2001423). However, conventional epoxy based TIMs, which are made from a mixture of thermal grease or epoxies and highly conductive fillers, suffer from low thermal conductivity due to the insulating nature of the grease or epoxy. Increasing filler concentration may enhance thermal conductivity, but it also raises the viscosity and stiffness of the composite, significantly reducing the compliance of the TIMs. Solder TIMs exhibit low TCR, but their mechanical stiffness can lead to high-stress failure due to thermal expansion mismatch between mating materials, limiting their application (Bar-Cohen et al., 2015, Journal of Electronic Packaging, 137, 040803).

On the other hand, aligned conductive nanostructures with mechanical compliance have emerged as promising candidates for TIMs. These structures minimize the heat transfer path across interfaces and alleviate thermomechanical stresses at mating material interfaces (Barako et al., 2015, ACS Applied Materials & Interfaces, 7, 19251).

Vertically aligned carbon nanotubes (CNTs) are an excellent example, possessing high thermal conductivity (>3000 W mK⁻¹) (Kim et al., 2001, Physical Review letters, 87, 215502) and low elastic modulus (Gao et al., 2012, Carbon, 50, 3789). To accommodate microscopically rough surfaces, double-sided conductive and compliant nanostructures hold great potential for TIMs. Double-sided CNTs prepared using chemical vapor deposition (CVD) have been explored as TIMs, with reported TCR values ranging from 3.5 mm² K W⁻¹ to 12 mm² K W⁻¹ (Wasniewski et al., 2012; Cola et al., 2007, Applied Physics Letters, 90, 093513; Wang et al., 2007, The Journal of Physical Chemistry C, 111, 12617). Despite progress in the use of CNTs for TIMs, their industrial application faces several challenges. The thermal performance of CNTs strongly depends on their microstructural quality, with factors such as entanglement, defects, nonuniformity, and process-induced damage leading to significant disparities in reported thermal conductivity (Zhu et al., 2007, 57^{th} Electronic Components and Technology Conference). Achieving large-scale, uniformly aligned CNTs arrays with improved process control is necessary for their commercial use as TIMs. Moreover, the harsh synthesis conditions, including high temperature and an inert gas environment, are incompatible with microelectronic fabrication processes, posing challenges for device integration and scalability. The poor long-term reliability resulting from weak adhesion of CNTs to sheets further limits their application in microelectronics. Although strategies have been developed to separate high-temperature growth and low-temperature CNTs device assembly, the resulting TCR remains high (43 mm² K W⁻¹). In addition to CNTs, double-sided tin NWs array was explored as a potential TIM. Tin NWs were prepared by hot-pressing soft tin foil into the holes of an anode aluminum oxide (AAO) template, resulting in a TCR of 20 mm² K W⁻¹ at 1 MPa.

Thus, there is a need in the art for novel methods to fabricate thermal interface materials with control and tunability. The present invention satisfies this unmet need.

### SUMMARY OF THE INVENTION

The present invention relates to a method of making an interfacial material, comprising the steps of: providing a double-sided substrate; adhering a template to at least one side of the double-sided substrate to provide at least one templated side of the double-sided substrate; exposing the double-sided substrate to a solution comprising a metal ion; and reducing the metal ion to form a metal, thereby bonding the metal to the at least one templated side of the double-sided substrate in a controlled geometry.

In some embodiments, the metal is distributed on both sides of the double-sided substrate in a controlled geometry. In some embodiments, the template comprises pores. In some embodiments, the template comprises cylindrical pores. In some embodiments, the template comprises pores having an average pore diameter of about 0.1 μm to about 1.0 μm.

In some embodiments, the solution comprising a metal ion comprises a copper ion. In some embodiments, the solution comprising a metal ion comprises a metal precursor selected from copper sulfate, copper chloride, copper hydroxide, copper nitrate, copper oxide, copper acetate, copper fluoride, copper bromide, copper carbonate, or copper triflate. In some embodiments, the solution comprising a metal ion comprises the metal ion in a concentration of at least 0.1 M. In some embodiments, the step of reducing the metal ion comprising supplying the solution with a constant voltage. In some embodiments, the method further comprises the step of removing the template. In some embodiments, the present invention provides a material made using the method described herein.

The present invention further relates to a material comprising a double-sided substrate, wherein a metal is distributed on at least one side of the double-sided substrate in a wire array, wherein the wire array comprises a plurality of wires having an average diameter of about 0.1 μm to about 1.0 μm.

In some embodiments, the at least one metal is distributed on both sides of the double-sided substrate in a wire array. In some embodiments, the double-sided substrate comprises copper. In some embodiments, the double-sided substrate is flat. In some embodiments, the metal is copper. In some embodiments, the wire array is a nanowire array. In some embodiments, the double-sided substrate has a thickness of 0.1 mm to 2.0 mm. In some embodiments, the present invention provides a device comprising the material described herein.

The present invention further relates to a device comprising a material comprising a double-sided substrate and a metal distributed on both sides of the double-sided substrate in a wire array, wherein the wire array comprises a plurality of wires having an average diameter of about 0.1 μm to about 1.0 μm.

### BRIEF DESCRIPTION OF THE DRAWINGS

The following detailed description of various embodiments of the invention will be better understood when read in conjunction with the appended drawings. For the purpose of illustrating the invention, these are shown in the drawings illustrative embodiments. It should be understood, however, that the invention is not limited to the precise arrangements and instrumentalities of the embodiments shown in the drawings.

FIG. 1, comprising FIG. 1A through FIG. 1C, depicts schematics of the first synthesis step. FIG. 1A depicts a representative stacking structure fixed with an acrylic fixture.

FIG. 1B depicts a cross sectional illustration of the stacking structure. FIG. 1C depicts a copper (Cu) substrate with polycarbonate track-etched (PCTE) templates bonded on both sides.

FIG. 2 depicts a schematic illustration of the sample fixture in the 2^{nd} synthesis step.

FIG. 3, comprising FIG. 3A and FIG. 3B, depicts representative thermal contact resistance measurements. FIG. 3A depicts a schematic illustration of the setup for thermal resistance measurement for three cases: (1) two meter bars in direct contact without an intermediate Cu sheet; (2) with an intermediate Cu sheet without nanowires (NWs); (3) with an intermediate Cu sheet grown with Cu NWs. FIG. 3B depicts an example of the temperature profile showing the temperature gradients along the length of the meter bars.

FIG. 4 depicts a schematic illustration of the setup for electrical contact resistance measurement for three cases: (1) two meter bars are in direct contact without an intermediate Cu; (2) with an intermediate Cu substrate without NWs; (3) with an intermediate Cu substrate grown with Cu NWs.

FIG. 5, comprising FIG. 5A and FIG. 5B, depicts images of double-sided Cu NWs. FIG. 5A depicts pictures of double-sided Cu NWs on Cu. FIG. 5B depicts scanning electron microscopy (SEM) images of Cu NWs. Inset: higher magnification SEM image of Cu NWs.

FIG. 6, comprising FIG. 6A through FIG. 6D, depicts SEM images of the mating materials. FIG. 6A depicts a representative SEM image of the mating material as-received. FIG. 6B depicts a representative SEM image of the mating material brushed. FIG. 6C depicts a representative SEM image of the mating material polished. FIG. 6D depicts surface roughness of the four mating materials.

FIG. 7 depicts an atomic force microscopy (AFM) image of the as-received Cu piece.

FIG. 8, comprising FIG. 8A and FIG. 8B, depicts representative results of thermal contact resistance (TCR) measurements. FIG. 8A depicts measured thermal resistance as a function of applied pressure for three different cases: (1) two Cu meter bars in direct contact without an intermediate Cu sheet; (2) with an intermediate Cu sheet without Cu NWs between two meter bars; (3) with an intermediate Cu with Cu NWs between two meter bars. FIG. 8B depicts measured thermal resistance as a function of applied pressure specifically for case 3.

FIG. 9, comprising FIG. 9A through FIG. 9C, depicts thermal circuit representations of the TCR measurements for three cases. FIG. 9A depicts a case where two meter bars are in direct contact without an intermediate Cu substrate. FIG. 9B depicts a case with an intermediate Cu substrate without Cu NWs. FIG. 9C depicts a case with an intermediate Cu substrate with Cu NWs.

FIG. 10, comprising FIG. 10A through FIG. 10C, depicts COMSOL simulation results for TCR. FIG. 10A depicts temperature distribution across the interfaces for the case when two Cu meter bars are in direct contact without Cu NWs and for the case when a Cu NWs array was placed between the meter bars. FIG. 10B depicts the temperature profile across the meter bars without Cu NWs. FIG. 10C depicts the temperature profile across the meter bars with Cu NWs.

FIG. 11, comprising FIG. 11A through FIG. 11C, depicts contact resistance as a function of applied pressure for different mating materials: as-received (1); brushed (2); polished Cu (3) in three cases. FIG. 11A depicts a case without an intermediate Cu sheet. FIG. 11B depicts a case with an intermediate Cu sheet without Cu NWs. FIG. 11C depicts a case with an intermediate Cu sheet with Cu NWs.

FIG. 12, comprising FIG. 12A and FIG. 12B, depicts thermal circuit configurations. FIG. 12A depicts a schematic illustration of the Cu mating materials alignment for contact resistance measurement in three cases: (1) without an intermediate Cu substrate; (2) with an intermediate Cu substrate without Cu NWs; (3) with an intermediate Cu substrate with Cu NWs on both sides. FIG. 12B depicts electrical resistance circuit representation of the resistance in three cases. Here, R_{Cu top} is the top bulk Cu resistance, R_{Cu top-Cu bottom} is the interface resistance between the top and bottom Cu pieces, and R_{Cu bottom} is the bottom bulk Cu resistance, R_{Cu top-Cu intermediate} is the interface resistance between the top and intermediate Cu substrate, R_{Cu intermediate} is the bulk resistance of the intermediate Cu substrate, R_{Cu intermediate-Cu bottom} is the interface resistance between intermediate Cu substrate and bottom Cu pieces, R_{Cu top-Cu NWs} is the interface resistance between top Cu piece and Cu NWs, R_{Cu bottom-Cu NWs} is the interface resistance between bottom Cu piece and Cu NWs.

FIG. 13, comprising FIG. 13A through FIG. 13D, depicts pictures of the Loctite® 3888 surface filler boned. FIG. 13A depicts as-received Cu. FIG. 13B depicts brushed Cu. FIG. 13C depicts polished Cu. FIG. 13D depicts a picture of the ECR measurement example.

FIG. 14, comprising FIG. 14A through FIG. 14C, depicts COMSOL simulation results for electrical contact resistance (ECR). FIG. 14A depicts voltage distribution across the interfaces for the case when two Cu meter bars are in direct contact without Cu NWs and for the case when a Cu NWs array was placed between the meter bars. FIG. 14B depicts the voltage profile across the meter bars without Cu NWs. FIG. 14C depicts voltage profile across the meter bars with Cu NWs.

### DETAILED DESCRIPTION

The present invention relates to methods of preparing compositions comprising at least one antibacterial compound. In various aspects of the present invention, the compositions prepared using the methods of the present invention are used in the treatment of wounds.

### Definitions

As used herein, each of the following terms has the meaning associated with it in this section. Unless defined elsewhere, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

The articles “a” and “an” are used herein to refer to one or to more than one (i.e. to at least one) of the grammatical object of the article. By way of example, “an element” means one element or more than one element.

The term “about” will be understood by persons of ordinary skill in the art and will vary to some extent depending on the context in which it is used. As used herein when referring to a measurable value such as an amount, a temporal duration, and the like, the term “about” is meant to encompass variations of 20% or ±10%, more preferably ±5%, even more preferably ±1%, and still more preferably ±0.1% from the specified value, as such variations are appropriate to perform the disclosed methods.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

### Methods of Fabricating Materials

In one aspect, the present invention relates to a method of making a material comprising a double-sided substrate and at least one metal distributed on the double-sided substrate in a controlled geometry. In some embodiments, the present invention provides a method of making a material comprising a double-sided substrate having at least one metal distributed on at least one side of the double-sided substrate in a controlled geometry, the method comprising the steps of: providing a double-sided substrate; adhering a template to at least one side of the double-sided substrate to provide at least one templated side of the double-sided substrate; exposing the double-sided substrate to a solution comprising a metal ion; and reducing the metal ion to form a metal, thereby bonding the metal to the at least one templated side of the double-sided substrate in a controlled geometry. In some embodiments, the present invention provides a method of making a material comprising a double-sided substrate having at least one metal distributed on both sides of the double-sided substrate in a controlled geometry, the method comprising the steps of: providing a double-sided substrate; adhering a template to both sides of the double-sided substrate; exposing the double-sided substrate to a solution comprising a metal ion; and reducing the metal ion to form a metal, thereby bonding the metal to both sides of the double-sided substrate. In some embodiments, the material comprises a metal distributed on at least one side of the double-sided substrate in a nanowire array. In some embodiments, the material comprises a metal distributed on both sides of the double-sided substrate in a nanowire array. The term “array,” as used herein, refers to a group of elements wherein the elements are ordered in rows and columns.

In some embodiments, the double-sided substrate comprises a metal. In some embodiments, the double-sided substrate comprises at least one alloy. In some embodiments, the double-sided substrate comprises at least one metal, at least one alloy comprising at least one metal, or a combination thereof. Exemplary metals of the double-sided substrate include, but are not limited to, lithium, sodium, potassium, magnesium, calcium, scandium, titanium, vanadium, chromium, manganese, iron, cobalt, nickel, copper, zinc, molybdenum, ruthenium, rhodium, palladium, silver, tungsten, iridium, platinum, gold, aluminum, gallium, indium, and any oxidation state thereof. For example, in some embodiments, the metal is copper. In some embodiments, the double-sided substrate is selected from the group consisting of aluminum, magnesium, titanium, silver, gold, platinum, nickel, cobalt, zinc, tin, and copper.

In some embodiments, the template is a membrane. In some embodiments, the template is a porous membrane. In some embodiments, the template comprises a polymeric material. In some embodiments, the template comprises a thermoplastic. In some embodiments, the template is a polycarbonate film. In some embodiments, the template is polycarbonate track etch (PCTE). Other exemplary polymeric materials include, but are not limited to, a polyisoprene, polybutadiene, polysiloxane, polyacrylate, polysulfide, polystyrene, polyacrylonitrile, halogenated elastomer, perhalogenated elastomer, polyether, polyamide, and combinations or copolymers thereof.

In some embodiments, the template comprises pores. In some embodiments, the pores have a circular cross section. In some embodiments, the template comprises cylindrical pores.

In some embodiments, the template comprises pores having an average pore diameter of about 0.1 μm to about 1.0 μm. In some embodiments, the template comprises pores having an average pore diameter of about 0.1 μm to about 0.9 μm. In some embodiments, the template comprises pores having an average pore diameter of about 0.1 μm to about 0.8 μm. In some embodiments, the template comprises pores having an average pore diameter of about 0.1 μm to about 0.7 μm. In some embodiments, the template comprises pores having an average pore diameter of about 0.1 μm to about 0.6 μm. In some embodiments, the template comprises pores having an average pore diameter of about 0.1 μm to about 0.5 μm. In some embodiments, the template comprises pores having an average pore diameter of about 0.2 μm to about 0.5 μm. In some embodiments, the template comprises pores having an average pore diameter of about 0.3 μm to about 0.5 μm. In some embodiments, the template comprises pores having an average pore diameter of about 0.4 μm to about 0.5 μm. In some embodiments, the template comprises pores having an average pore diameter of about 0.2 μm to about 1.0 μm. In some embodiments, the template comprises pores having an average pore diameter of about 0.3 μm to about 1.0 μm. In some embodiments, the template comprises pores having an average pore diameter of about 0.4 μm to about 1.0 μm. In some embodiments, the template comprises pores having an average pore diameter of about 0.5 μm to about 1.0 μm. In some embodiments, the template comprises pores having an average pore diameter of about 0.6 μm to about 1.0 μm. In some embodiments, the template comprises pores having an average pore diameter of about 0.7 μm to about 1.0 μm. In some embodiments, the template comprises pores having an average pore diameter of at least about 0.1 μm, 0.2 μm, 0.3 μm, 0.4 μm, 0.5 μm, 0.6 μm, 0.7 μm, 0.8 μm, 0.9 μm, or 1.0 μm.

In some embodiments, the solution comprising a metal ion comprises a metal salt which comprises the metal ion. In some embodiments, the metal salt dissociates in the solution to form the metal ion. As used herein, the term “metal salt” can be used interchangeably with “metal precursor”. Exemplary metal ions or metals which may be included in a metal precursor or metal salt include, but are not limited to, lithium, sodium, potassium, calcium, scandium, titanium, vanadium, chromium, manganese, iron, cobalt, nickel, copper, zinc, molybdenum, ruthenium, rhodium, palladium, silver, tungsten, iridium, platinum, gold, aluminum, gallium, indium, ions thereof, and any oxidation state thereof. In some embodiments, the metal ion is a copper ion. In some embodiments, the solution comprises a metal precursor selected from copper sulfate, copper chloride, copper hydroxide, copper nitrate, copper oxide, copper acetate, copper fluoride, copper bromide, copper carbonate, copper triflate, and any combination thereof. In some embodiments, the metal ion is copper. In some embodiments, the solution comprises copper sulfate.

In some embodiments, the solution comprising a metal ion further comprises an organic counterion. In some embodiments, the solution comprising a metal ion further comprises an inorganic counterion. Exemplary counterions include, but are not limited to, halides, borates, phosphates, carbonates, oxides, perchlorates, nitrates, and sulfates.

In some embodiments, the solution comprising a metal ion further comprises an organic solvent. In some embodiments, the solution comprising a metal ion further comprises water. In some embodiments, the solution comprising a metal ion further comprises a mixture of organic and aqueous solvents.

In some embodiments, the solution comprising a metal ion further comprises a one polar solvent. Examples of such polar solvents include, but are not limited to, water, glycerin, propylene glycol, ethylene glycol, tetraethylene glycol, triethylene glycol, trimethylene glycol, acetone, acetonitrile, dimethylformamide, dimethylsulfoxide, isopropanol, methanol, ethanol, tetrahydrofuran, formic acid, nitromethane, and combinations thereof.

In some embodiments, the solution comprising a metal ion further comprises a non-polar solvent. Examples of such non-polar solvents include, but are not limited to, alkanes, including but not limited to cycloalkanes, propane, pentane, hexane, and heptane, benzene, toluene, xylene, chloroform, diethyl ether, ethyl acetate, dichloromethane, toluene, and combinations thereof.

In some embodiments, the solution comprising a metal ion further comprises an acid. Exemplary acids include, but are not limited to, HF, HCl, HBr, HI, H₂SO₄, HNO₃, HClO₄ and HClO₃.

In some embodiments, the solution comprising a metal ion has a pH of at least about 1, 2, 3, 4, 5, 6, 7, 8, 9, 10, 11, 12, 13, or 14.

In some embodiments, the solution comprising a metal ion comprises the metal ion in a concentration of about 0.01 M to about 5.0 M. In some embodiments, the solution comprising a metal ion comprises the metal ion in a concentration of about 0.1 M to about 5.0 M. In some embodiments, the solution comprising a metal ion comprises the metal ion in a concentration of about 0.1 M to about 4.0 M. In some embodiments, the solution comprising a metal ion comprises the metal ion in a concentration of about 0.1 M to about 3.0 M. In some embodiments, the solution comprising a metal ion comprises the metal ion in a concentration of about 0.1 M to about 2.0 M. In some embodiments, the solution comprising a metal ion comprises the metal ion in a concentration of about 0.1 M to about 1.0 M. In some embodiments, the solution comprising a metal ion comprises the metal ion in a concentration of about 0.2 M to about 1.0 M. In some embodiments, the solution comprising a metal ion comprises the metal ion in a concentration of about 0.3 M to about 1.0 M. In some embodiments, the solution comprising a metal ion comprises the metal ion in a concentration of about 0.4 M to about 1.0 M. In some embodiments, the solution comprising a metal ion comprises the metal ion in a concentration of about 0.5 M to about 1.0 M. In some embodiments, the solution comprising a metal ion comprises the metal ion in a concentration of about 0.6 M to about 1.0 M. In some embodiments, the solution comprising a metal ion comprises the metal ion in a concentration of about 0.7 M to about 1.0 M. In some embodiments, the solution comprising a metal ion comprises the metal ion in a concentration of about 0.8 M to about 1.0 M. In some embodiments, the solution comprising a metal ion comprises the metal ion in a concentration of about 0.9 M to about 1.0 M. In some embodiments, the solution comprising a metal ion comprises the metal ion in a concentration of at least about 0.01 M, 0.1 M, 0.2 M, 0.3 M, 0.4 M, 0.5 M, 0.6 M, 0.7 M, 0.8 M, 0.9 M, 1.0 M, 2.0 M, 3.0 M, 4.0 M, or 5.0 M. In some embodiments, the metal ion is in the form of a metal precursor. In some embodiments, the metal ion is in the form of a metal salt.

In some embodiments, the step of reducing the metal ion results in electrodeposition of the metal on the double-sided substrate. In some embodiments, the step of reducing the metal ion results in electroplating of the metal on the double-sided substrate.

The term “electrodeposition” refers to electroplating processes, in which the deposited metal or alloy adheres to the substrate surface, and to electroforming processes, in which the deposited metal or alloy is detached from the substrate surface after it is deposited.

In some embodiments, the step of reducing the metal ion is performed by supplying a constant voltage to the solution having a magnitude of less than about 0.1 V, about 0.1 V to about 1.0 V, about 0.2 V to about 1.0 V, about 0.3 V to about 1.0 V, about 0.4 V to about 1.0 V, about 0.5 V to about 1.0 V, about 0.6 V to about 1.0 V, about 0.7 V to about 1.0 V, about 0.8 V to about 1.0 V, about 0.9 V to about 1.0 V, or at least about 1.0 V. In some embodiments, the voltage supplied has a magnitude of at least about 0.1 V, 0.2 V, 0.3 V, 0.4 V, 0.5 V, 0.6 V, 0.7 V, 0.8 V, 0.9 V, or 1.0 V. In some embodiments, the voltage is negative. In some embodiments, the voltage is about −0.4 V.

In some embodiments, the method further comprises the step of removing the template. In some embodiments, the template is removed by dissolving the template in a solvent. Exemplary solvents include, but are not limited to, dichloromethane, tetrahydrofuran, acetone, dimethylformamide, acetonitrile, or dimethylsulfoxide. In some embodiments, the template is mechanically removed from the substrate.

### Materials

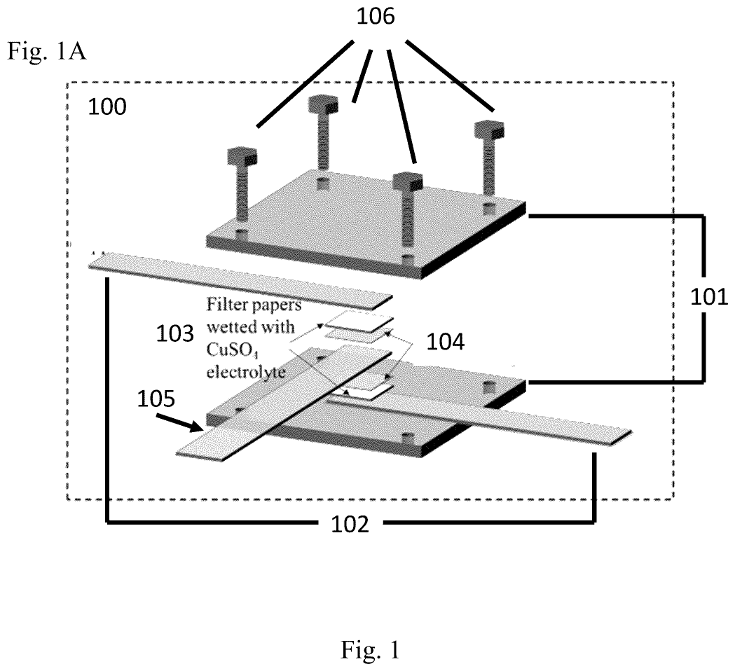

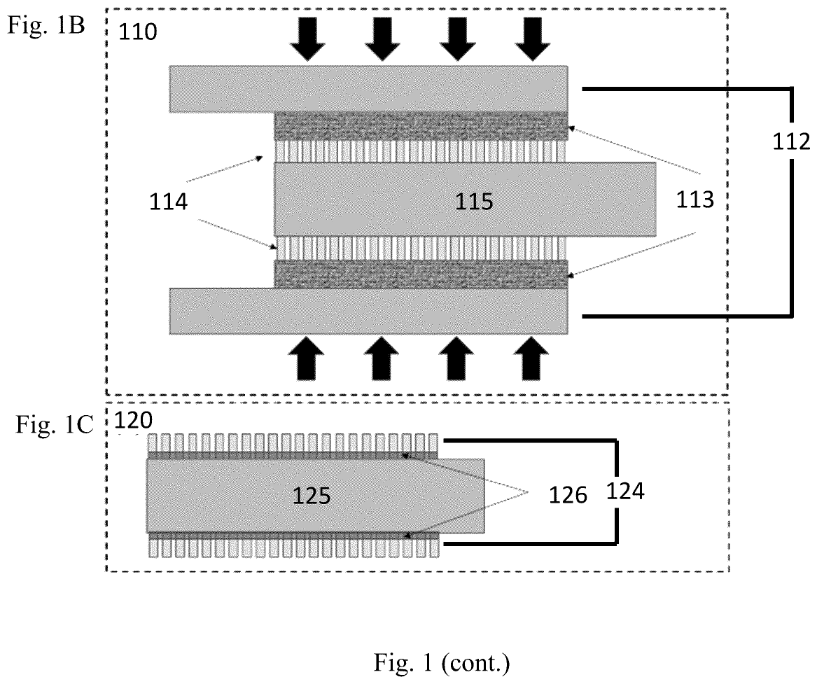

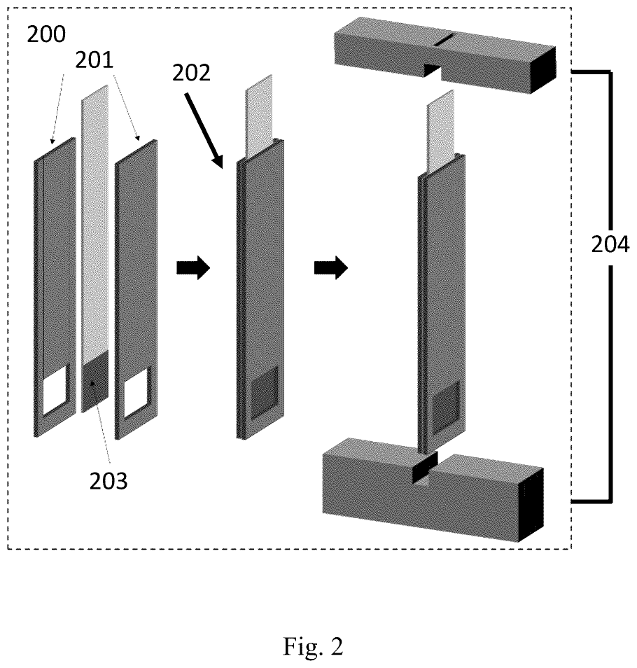

The present invention further relates to, in part, a material comprising a double-sided substrate, wherein a metal is distributed on at least one side of the double-sided substrate. In some embodiments, the metal is distributed on at least one side of the double-sided substrate in a controlled geometry. Exemplary materials of the present invention include, but are not limited to, a material made using a method of the present invention, i.e. as shown in FIG. 1 or 2.

In some embodiments, the double-sided substrate comprises at least one metal. In some embodiments, the double-sided substrate comprises at least one alloy. In some embodiments, the double-sided substrate comprises at least one metal, at least one alloy comprising at least one metal, or a combination thereof. Exemplary metals include, but are not limited to, lithium, sodium, potassium, magnesium, calcium, scandium, titanium, vanadium, chromium, manganese, iron, cobalt, nickel, copper, zinc, molybdenum, ruthenium, rhodium, palladium, silver, tungsten, iridium, platinum, gold, aluminum, gallium, indium, and any oxidation state thereof. For example, in some embodiments, the metal is copper. In some embodiments, the at least one metal is selected from the group consisting of aluminum, magnesium, titanium, silver, gold, platinum, nickel, cobalt, zinc, tin, and copper.

In some embodiments, the double-sided substrate is flat. In some embodiments, the double-sided substrate is rounded. In some embodiments, the double-sided substrate is rectangular.

In some embodiments, the double-sided substrate has a thickness of less than about 0.1 mm, about 0.1 mm to about 2.0 mm, about 0.2 mm to about 2.0 mm, about 0.3 mm to about 2.0 mm, about 0.4 mm to about 2.0 mm, about 0.5 mm to about 2.0 mm, about 0.6 mm to about 2.0 mm, about 0.7 mm to about 2.0 mm, about 0.8 mm to about 2.0 mm, about 0.9 mm to about 2.0 mm, about 1.0 mm to about 2.0 mm, about 1.0 mm to about 1.9 mm, about 1.0 mm to about 1.8 mm, about 1.0 mm to about 1.7 mm, about 1.0 mm to about 1.6 mm, about 1.0 mm to about 1.5 mm, about 1.0 mm to about 1.4 mm, about 1.0 mm to about 1.3 mm, about 1.0 mm to about 1.2 mm, or about 1.0 mm to about 1.1 mm. In some embodiments, the double-sided substrate has a thickness of at least about 0.1 mm, 0.2 mm, 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, or 2.0 mm.

In some embodiments, the metal is uniformly distributed on the substrate. In some embodiments, the metal is randomly distributed on the substrate. In some embodiments, the metal is vertically aligned. In some embodiments, the metal is tilted.

In some embodiments, the metal is distributed on the substrate in an array. In some embodiments, the metal is distributed on the substrate in a wire array. In some embodiments, the metal is distributed on the substrate in a microwire array. In some embodiments, the metal is distributed as a nanowire array. In some embodiments, the metal is distributed as nanotubes. In some embodiments, the metal is distributed as cylinders.

In some embodiments, the metal is distributed as a plurality of wires having a circular cross-section. In some embodiments, the plurality of wires have an average diameter of about 0.1 μm to about 1.0 μm. In some embodiments, the plurality of wires have an average diameter of about 0.1 μm to about 0.9 μm. In some embodiments, the plurality of wires have an average diameter of about 0.1 μm to about 0.8 μm. In some embodiments, the plurality of wires have an average diameter of about 0.1 μm to about 0.7 μm. In some embodiments, the plurality of wires have an average diameter of about 0.1 μm to about 0.6 μm. In some embodiments, the plurality of wires have an average diameter of about 0.1 μm to about 0.5 μm. In some embodiments, the plurality of wires have an average diameter of about 0.2 μm to about 0.5 μm. In some embodiments, the plurality of wires have an average diameter of about 0.3 μm to about 0.5 μm. In some embodiments, the plurality of wires have an average diameter of about 0.4 μm to about 0.5 μm. In some embodiments, the plurality of wires have an average diameter of about 0.2 μm to about 1.0 μm. In some embodiments, the plurality of wires have an average diameter of about 0.3 μm to about 1.0 μm. In some embodiments, the plurality of wires have an average diameter of about 0.4 μm to about 1.0 μm. In some embodiments, the plurality of wires have an average diameter of about 0.5 μm to about 1.0 μm. In some embodiments, the plurality of wires have an average diameter of about 0.6 μm to about 1.0 μm. In some embodiments, the plurality of wires have an average diameter of about 0.7 μm to about 1.0 μm. In some embodiments, the plurality of wires have an average diameter of about 0.1 μm, 0.2 μm, 0.3 μm, 0.4 μm, 0.5 μm, 0.6 μm, 0.7 μm, 0.8 μm, 0.9 μm, or 1.0 μm.

In some embodiments, the material enhances the current flow between an electrical interconnection. In some embodiments, the material is used as an interfacial material. In some embodiments, the material is used as bonding between devices. In some embodiments, the material is used as a thermal management component.

### Devices

The present invention further provides, in part, a device for the fabrication of a material described herein or comprising a material described herein.

In some embodiments, the stacking structure 100 in FIG. 1A can be employed as a device for the fabrication of the present material using any method disclosed herein. In some embodiments, the stacking structure 100 comprises a series of layers including metal substrate 105 disposed between two polymeric templates 104. In some embodiments, the polymeric templates 104 are porous membrane materials. In some embodiments, the metal substrate 105 and polymeric templates 104 are further sandwiched between two filter papers 103 saturated with a solution comprising at least one metal, which are further sandwiched between two electrodes 102. In some embodiments, the resulting stack is aligned within two stacking plates 101 held together using bolts 106. In some embodiments, the stacking structure 100 is secured upon tightening of bolts 106. In some embodiments, a voltage is applied between the two electrodes 102 to induce nanowire growth onto the substrate and within the template.

As used herein, the term “nanowire” generally refers to any elongated conductive or semiconductive material (or other material described herein) that includes at least one cross sectional dimension that is less than 500 nm, including, for example, less than 100 nm, and has an aspect ratio (length:width) of greater than 10, including, for example, greater than 50, greater than 100, and/or greater than 1000.

In some embodiments, the stacking structure 100 can be visualized as cross-section 110 in FIG. 1B comprising metal substrate 115 sandwiched between templates 114 subsequently sandwiched between two filter papers 113 which are further sandwiched between two electrodes 112.

In some embodiments, the resulting material comprises a region 120 in FIG. 1C wherein the metal substrate 125 is fused to polymeric templates 124 and further comprises metal nanowires 126. In some embodiments, metal nanowires 126 protrude slightly from the metal substrate 125 into the polymeric templates 124 to bond them together.

In some embodiments, the resulting material is further sandwiched 200 as shown in FIG. 2 between two plates 201 that expose the region 203 which comprises the polymeric templates and metal nanowires. In some embodiments, the sandwiched fixture 202 is inserted into fixture 204. In some embodiments, the affixed 202 and 204 are placed into a solution comprising at least one metal and exposed to a voltage. In some embodiments, the affixed 202 and 204 are placed into a solution comprising at least one metal and exposed to a voltage for at least about 1 minute, 5 minutes, 10 minutes, 15 minutes, 20 minutes, 30 minutes, or 1 hour. In some embodiments, the sandwiched fixture 202 is subsequently removed from fixture 204 and plates 201 are removed to reveal a final material. In some embodiments, the polymeric templates are removed from region 203.

In some embodiments, the present invention provides a material comprising a double-sided substrate and at least one metal distributed on at least one side of the double-sided substrate. In some embodiments, the present invention provides, in part, a device for the fabrication of a material comprising a double-sided substrate and at least one metal distributed on both sides of the double-sided substrate. Exemplary devices of the present invention include, but are not limited to, stacking structure 100, fixture 202, and fixture 204 as described elsewhere herein.

In some embodiments, the present invention provides a device comprising a material comprising a double-sided substrate and at least one metal distributed on at least one side of the double-sided substrate. In some embodiments, the present invention provides a device comprising a material comprising a double-sided substrate and at least one metal distributed on both sides of the double-sided substrate.

In some embodiments, the device comprises a membrane, interfacial material, electrical interfacial material, thermal interfacial material, or a combination thereof. In some embodiments, the device reduces contact resistance in an electrical interconnection. In some embodiments, the device increases the contact spots between an electrical interconnection. In some embodiments, the device increases the current flow between an electrical interconnection.

In some embodiments, the device is a resistor. In some embodiments, the device is an electronic device. In some embodiments, the device is a computer chip. In some embodiments, the device is a cooling device. In some embodiments, the device is a battery pack. In some embodiments, the material is used as an interface. In some embodiments, the material is used as bonding between devices. In some embodiments, the material is used as a thermal management component. some embodiments, the device is an electrical connector. In some embodiments, the device is a washer.

### EXPERIMENTAL EXAMPLES

The invention is now described with reference to the following Examples. These Examples are provided for the purpose of illustration only and the invention should in no way be construed as being limited to these Examples, but rather should be construed to encompass any and all variations which become evident as a result of the teaching provided herein.

Without further description, it is believed that one of ordinary skill in the art can, using the preceding description and the following illustrative examples, make and utilize the compositions of the present invention and practice the claimed methods. The following working examples therefore and are not to be construed as limiting in any way the remainder of the disclosure.

Vertically aligned copper nanowires (Cu NWs) are potential candidate thermal interface materials (TIMs) due to their high thermal conductivity and mechanical compliance resulting from the high aspect ratio (Liu et al., 2018, Materials Research Express, 5, 096416; Jing et al., 2023, ACS Nano, 17, 2602). A literature review has shown that single-sided Cu NWs has been explored as TIMs. For example, Gong et al. demonstrated a high-performance TIM using a heterogeneous Cu—Sn NW array, which they claimed can reduce the thermal resistance by two times compared with the state-of-art TIMs. Barako et al. used single sided vertically aligned Cu NWs embedded into polymer matrices as thermally conductive, mechanical compliant TIMs. Their reported thermal resistance is below 5 mm²KW⁻¹. More recently, Jing et al. demonstrated a 3D graphene-NW “sandwich” thermal interface with an ultralow thermal resistance of ˜0.24 mm²KW⁻¹. However, double-sided Cu NW arrays do not currently exist.

Similar to thermal management, effective electrical interconnection requires proper electrical management. Electrical contact resistance (ECR) arising from the microscale surface of mating materials (Baek & Fearing, 2008, IEEE Transactions on Components and Packaging Technologies, 31, 859) plays a crucial role in the performance of electromechanical devices, such as switches, relays, breakers, and connectors (Kogut & Komvopoulos, 2004, Journal of Applied Physics, 95, 576; Kogut & Komvopoulos, 2003, Journal of Applied Physics, 95, 3153; Brown et al., 2009, Journal of Micromechanics and Microengineering, 19, 025006). In practical applications, low and stable ECR is generally required over extended periods to prevent electrical contact deterioration, improve reliability, and prolong the lifetime of electronic devices. Higher ECR results in increased temperature due to Joule heating under constant current flow, which can influence the contact pressure through thermal expansion, subsequently affecting the ECR (Richard et al., 2003, Journal of Materials Processing Technology, 132, 119). The contact behavior of mating materials in electronic and microelectromechanical devices is largely influenced by surface roughness and asperities (Rezvanian et al., 2007, Journal of Micromechanics and Microengineering, 17, 2006; Avasarala & Haldar, 2009, Journal of Power Sources, 188, 225). Modeling and experimental work have indicated that less than 10% of the apparent contact area conducts electrical current, referred to as the real contact area.

Therefore, increasing the real contact area is one way to reduce the ECR. For instance, researchers have demonstrated that multiwalled carbon nanotubes (MWCNTs) (Tong et al., 2004, Integrated Nanosystems: Design, Synthesis, and Applications, 41774, 7) and conductive and compliant metal NWs arrays, such as nickel NWs array, can reduce ECR by promoting intimate contact with mating surfaces. However, as previously mentioned, CNTs have certain limitations for practical application, and nickel has inferior electrical conductivity compared to Cu. Therefore, vertically aligned Cu NW arrays are also excellent materials for electrical interconnection applications due to their exceptional electrical conductivity and mechanical compliance. Xu et al. (Xu et al., 2015, ACS Nano, 9, 241) demonstrated an environmentally stable Cu NW with superior electrical transport properties for interconnects application. The Cu NW showed temperature-dependent resistance in the temperature range from 25 to 300 K and retained a low resistivity of ˜3.5×10⁻⁶ Ω·cm at room temperature, near the resistivity of bulk Cu.

While CNTs hold promise for both thermal and electrical applications, there are still significant challenges for their large-scale industrial implementation, which may not be easily addressed in the short term. Hence, it could be beneficial to explore alternative candidates at this time.

In this work, for the first time, a novel method was developed to fabricate double-sided Cu NW arrays on a Cu sheet, which was utilized as interface layers between two contact surfaces for thermal and electrical applications. The results showed a significant reduction in TCR and ECR across the interfaces, making this double-sided Cu NWs layer a promising candidate for both TIMs and electrical interconnection applications.

High-performance and reliable thermal and electrical interfacial layers are in great demand across various industries, including semiconductors, automotive, aerospace and aviation, renewable energy, telecommunications, medical devices, industrial automation, consumer electronics, and more. The vertically aligned Cu NWs array exhibits high thermal and electrical conductivity as well as mechanical compliance, making it an ideal candidate for electrical and thermal applications. To accommodate the topography of the mating surfaces, double-sided Cu NWs arrays on Cu sheet were prepared and used as thermal and electrical interfacial layers. Experimental results demonstrated that the double-sided Cu NWs array significantly reduced the thermal contact resistance (TCR). The reported TCR is less than 5 mm² K W⁻¹, outperforming or being comparable to previously reported double-sided nanostructural TIMs. Furthermore, this performance is comparable to the best performance reported for other one-dimensional, one-sided nanostructures, such as CNTs and Cu NWs array.

The prepared double-sided Cu NWs array was also employed as an electrical interfacial layer to reduce electrical contact resistance (ECR), resulting in a dramatical reduction of ECR. This performance outperforms conductive grease when used for joints that require separable bonding, while it underperforms or is comparable to expensive silver-based conductive surface epoxy for joints that demand permanent and inseparable bonding. These results demonstrated the significant potential of the double-sided Cu NWs array for thermal interface materials (TIMs) and electrical interconnection applications. This performance was verified through COMSOL simulation.

The experimental methods used herein will now be described.

### Preparation of Double-Sided Cu NWs Array on Cu Sheet

Double-sided Cu NWs were grown on Cu sheets in two steps using a polycarbonate track etched (PCTE) template with a pore size of 0.4 m and a filling ratio of 19%. The following describes a typical process for synthesizing Cu NW arrays on both sides of an oxygen-free Cu sheet using a two-step electrodeposition method.

In the first step, an electrolyte solution consisting of 0.6 M CuSO₄ (as the Cu precursor) and 1 M H₂SO₄ (to increase conductivity) was pipetted onto two filter papers until they were sufficiently wetted. Then, two Cu counter electrodes, two pieces of wet filter paper, two PCTE templates, and the Cu sheet were carefully stacked and aligned using a specially designed fixture (FIG. 1A) as shown in the cross-section illustration in FIG. 1B. The stacking structure was secured by four bolts using a torque wrench under a fixed torque of 2 in-lbs to ensure uniform pressure and tight adherence of the PCTE template to the Cu sheet. The two Cu counter electrodes were connected by a lead wire. A constant voltage of −0.4 V was then applied using an electrochemical workstation (VersaSTAT 3, Ametek, Berwyn, PA, USA) between the counter electrodes and the Cu sheet. After approximately 8 minutes of bonding time, a thin layer of Cu NWs was grown on the Cu sheet and into the holes of the PCTE template, resulting in sufficient bonding between the two. The Cu sheet with attached PCTE templates on both sides (FIG. 1C) was then released from the stacking structure.

In the second step of the electrodeposition process, the Cu sheet with PCTE templates bonded on both sides was used as the working electrode. It was first sandwiched in a 3D-printed polylactic acid (PLA) fixture (FIG. 2). This fixture helped secure the working electrode while exposing the Cu NWs region (indicated by red in FIG. 2) to the electrolyte. The entire structure was then placed in a three-electrode electrochemical cell with an Ag/AgCl reference electrode. Another Cu sheet served as the counter electrode. Potentiostatic electrodeposition was performed at room temperature with a constant voltage of −0.4 V relative to the Ag/AgCl reference electrode. After 15 minutes of growth time, the Cu sheet was removed from the fixture, rinsed with deionized water, and immersed in dichloromethane (Sigma-Aldrich, St. Louis, MO, USA) for 1 h to fully dissolve the PCTE templates. Subsequently, the Cu sheet was rinsed with deionized water and ethanol, and then dried in air.

### Surface Morphology Characterization

The morphologies of the Cu NWs array and mating material surfaces were characterized using scanning electron microscopy (SEM, Quanta 450 FEG, Thermo Fisher-FEI, Hillsboro, OR, USA). The surface roughness of the mating materials was measured using a 3D laser scanning confocal microscope (Keyence VK-X1000, Keyence Corp., Osaka, Japan). The 3D surface profile of the as-received Cu was also captured using an atomic force microscope (AFM).

### Thermal Contact Resistance (TCR) Measurement

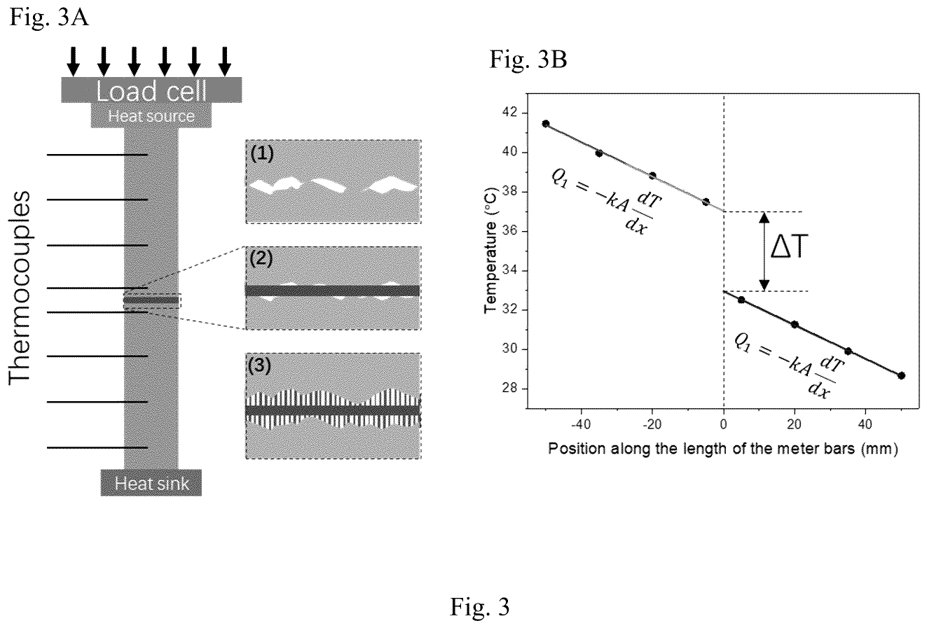

The thermal performance of the Cu NWs array was measured using a one-dimensional steady-state measurement setup in accordance with the ASTM D5470 standard (ASTM Standard D5470, Standard Test Method for Thermal Transmission Properties of Thermally Conductive Electrical Insulation Materials), as depicted in FIG. 3A. Two vertical Cu meter bars were aligned, with a cartridge heater (power: 200 W) positioned on top of one meter bar as the heat source. Cooling water was circulated at the bottom of the other meter bar to act as the heat sink. This configuration established a one-dimensional heat flow along the meter bars and through the sample. Eight thermocouples were placed along the length of the meter bars to record the temperatures. FIG. 3B illustrates an example of the temperature profile obtained from the eight thermocouples.

During testing, the entire apparatus was compressed by a Tinius Olsen H5KT universal testing machine (Tinius Olsen, Horsham, PA, USA) at pressures ranging from 1 MPa to 5 MPa. The temperature gradients at four locations on each meter bar were recorded, and the heat flows of the upper meter bar (Q₁) and the lower meter bar (Q₂) were calculated based on Fourier's law:

$${Q}_{1} = - k {A ( \frac{d T}{d x} )}_{1} \qquad ( Eq . 1 )$$

$${Q}_{2} = - k {A ( \frac{d T}{d x} )}_{2} \qquad ( Eq . 2 )$$

where k is the thermal conductivity of the Cu meter bars, and A is the cross-sectional area of the meter bar.

$${( \frac{d T}{d x} )}_{1} and {( \frac{d T}{d x} )}_{2}$$

are the temperature gradients of the upper and lower meter bars, respectively. These values were obtained by fitting the four temperature data points. The average heat flow (Q) was calculated as:

$$Q = \frac{( {Q}_{1} + {Q}_{2} )}{2} \qquad ( Eq . 3 )$$

The temperatures of the surfaces of the meter bars in contact with the sample (T_{H} and Tc) were determined by extrapolating the linear regression temperature profile in each meter bar to the sample locations (FIG. 3B). The total interfacial thermal resistance was calculated by dividing the temperature difference (ΔT) by the heat flow (Q):

$$Δ T = {T}_{H} - {T}_{C} \qquad ( Eq . 4 )$$

$$R = \frac{A * Δ T}{Q} \qquad ( Eq . 5 )$$

Three types of samples were prepared, as illustrated in FIG. 3A. In case 1, two Cu meter bars were in direct contact without any interlayer. In case 2, an intermediate Cu sheet without Cu NWs was placed between the meter bars, while in case 3, an intermediate Cu sheet grown with Cu NWs on both sides as a TIM was inserted between the two meter bars.

### Electrical Contact Resistance (ECR) Measurement

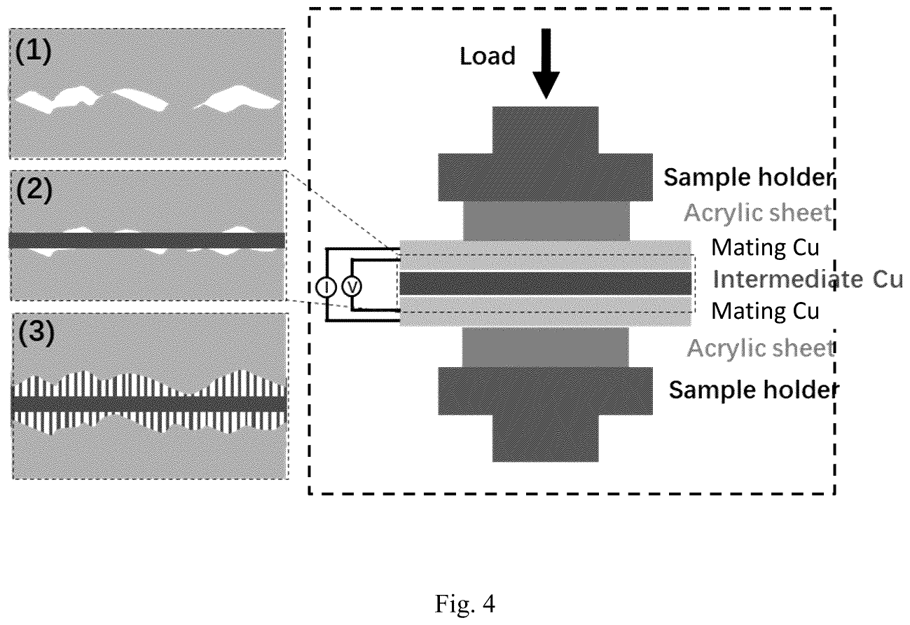

The setup for contact resistance measurement is illustrated in FIG. 4. The samples were stacked between two metal pieces: Cu (Alloy 110, ASTM B-152) with distinct surface finishes (as-received, brushed, and polished), which were obtained from a commercial source (McMaster-Carr, Robbinsville, NJ, USA). A constant current of 0.1 A was applied through the top and bottom Cu pieces, and the corresponding voltage drop was recorded by using Keithley 2400 SourceMeter (Tektronix, Beaverton, OR, USA). Meanwhile, pressure was applied and continuously increased using a Tinius Olsen H5KT universal testing machine (Tinius Olsen, Horsham, PA, USA) from 0 to 5 MPa.

### Finite Element Analysis Using COMSOL

To validate the performance of Cu NWs used as thermal interface materials and electrical interconnects, the commercial FEA program COMSOL Multiphysics (version 6.0, COMSOL Inc., Burlington, MA, USA) was employed to perform simulations by solving thermal and electric field equations through the finite element method (FEM). Two cases for both TCR and ECR simulation were compared: one with two Cu pieces in direct contact without Cu NWs, and the other with Cu NWs placed between the Cu pieces. The surface profiles for the mating surfaces were imported from AFM surface profile data to represent the real case. For the simplification of the simulation, only a slice of the Cu pieces with a width of 93 μm was simulated.

For the boundary conditions of the TCR simulation, the top end of the Cu meter bar was maintained at a temperature of 41° C., while the bottom end of the Cu meter bar was maintained at a temperature of 28° C. The contact model used is constriction conductance with interstitial gas. The initial temperature was set at 20° C. The lateral surfaces of both Cu meter bars were considered thermally insulated. The same boundary conditions were applied for the contacts, both with and without Cu NWs.

For the ECR simulation, a prescribed constant current 0.1 A/cm² was applied to the top-most surface of the upper Cu block, while the bottommost surface of the bottom Cu block was electrically grounded. The lateral surfaces of both Cu blocks were considered electrically insulated. For both TCR and ECR simulations, a finer physics-controlled mesh was utilized.

The results of the experiments will now be discussed herein.

### Morphology of Double-Sided Cu NWs

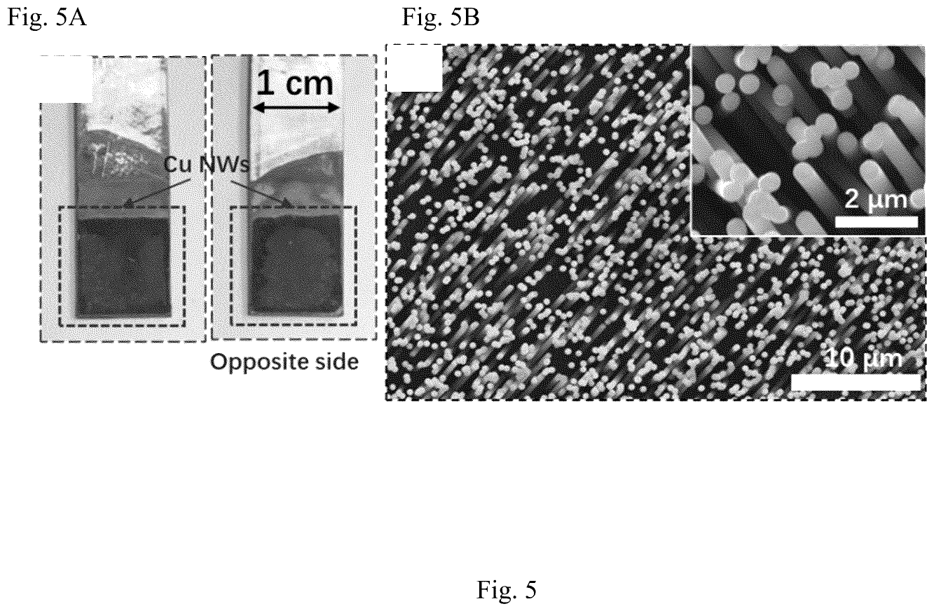

FIG. 5A displays images of the top and bottom surfaces of the double-sided Cu NWs regions on a Cu sheet. The area covered by the Cu NWs is visually darker and measures 1 cm×1 cm (indicated by dashed squares). FIG. 5B presents SEM images of the Cu NWs array. It can be observed that the Cu NWs are densely and uniformly distributed, exhibiting a random distribution of tilting angles up to 30°.

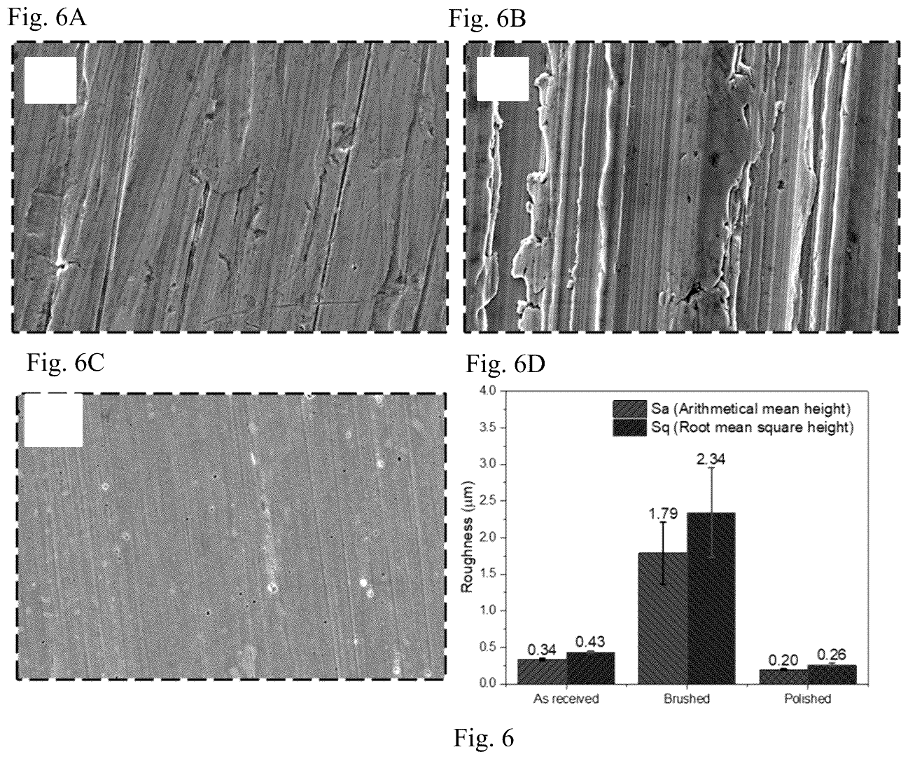

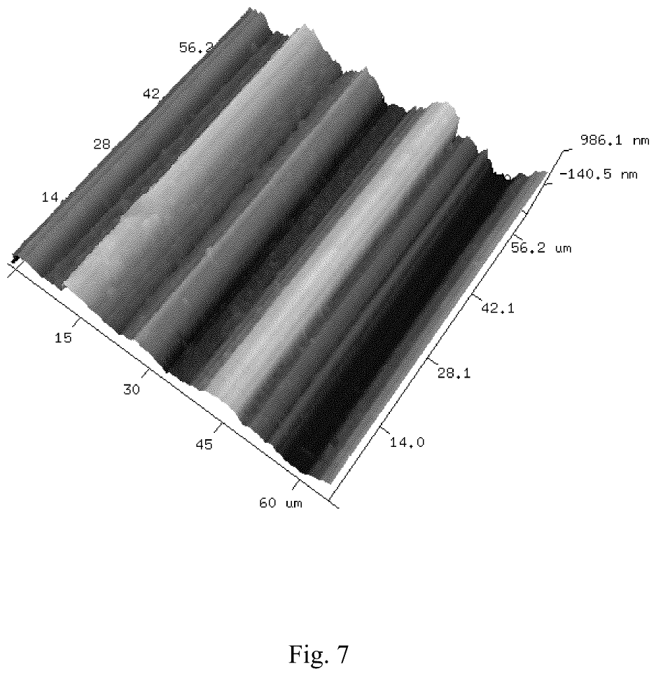

Considering the importance of surfaces in facilitating the engagement of NWs-free tips, the surface morphologies of the mating materials were first characterized. The SEM images of the surfaces of the mating materials are shown in FIG. 6A through FIG. 6D, respectively. Unidirectional scratches resulting from the machining process were found on the surfaces of all mating materials. Among them, the brushed Cu surface displayed the deepest scratches, corresponding to the highest roughness value (Sa: 1.79 um) (FIG. 6E). Conversely, the surface of the polished Cu exhibited very shallow scratches, indicating the smallest roughness (Sa: 0.2 um). The roughness of the as-received Cu surface (Sa: 0.34 um) fell between that of the polished Cu and brushed Cu (FIG. 6E). The AFM image of the as-received Cu (FIG. 7) also shows unidirectional scratches.

### Thermal Contact Resistance (TCR)

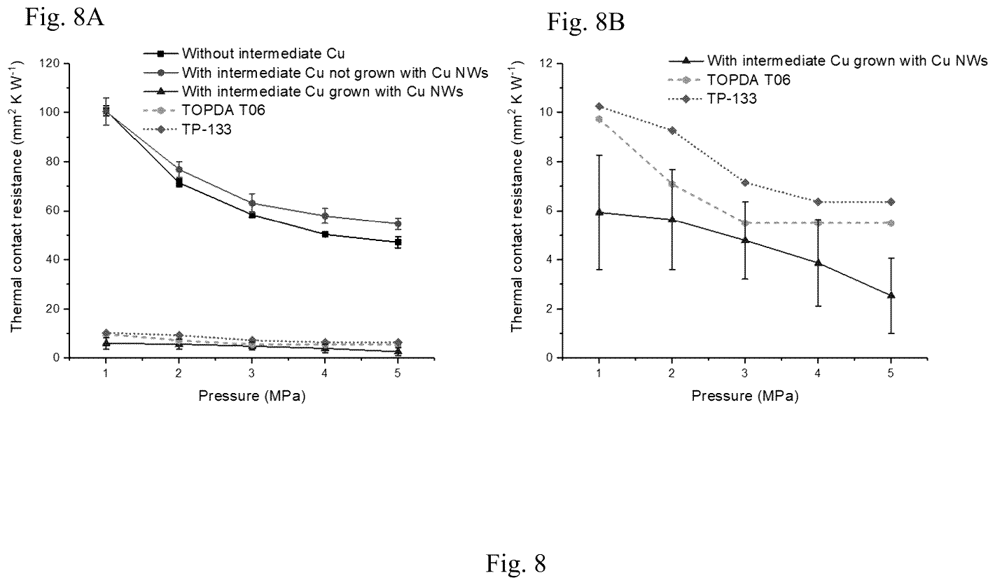

FIG. 8A shows the measured TCR as a function of pressure. In case 1 (black curve), where the two meter bars are in direct contact without an intermediate Cu sheet, the average TCR continuously dropped from 100 mm² K W⁻¹ to around 48 mm² K W⁻¹. In case 2 (red curve), with an intermediate Cu sheet without Cu NWs, the average TCR continuously decreased from 100 mm² K W⁻¹ to around 55 mm² K W⁻¹ under pressures ranging from 1 MPa to 5 MPa. The measured total contact resistance is higher than that of case 1. In case 3 (blue curve), with an intermediate Cu with Cu NWs as a TIM between the two meter bars, the TCR decreased from 6 mm² K W⁻¹ to around 2.5 mm² K W⁻¹ under pressures ranging from 1 MPa to 5 MPa (FIG. 8B), significantly lower than those of cases 1 and 2. This result outperforms or is comparable to double-sided CNTs and outperforms the reported double-sided tin NWs, shown below. Additionally, this performance is comparable to the best performance reported for other one-sided 1D nanostructures such as CNTs (Cross et al., 2010, Nanotechnology, 21, 445705) and Cu NWs array.

| | | Thermal |
|---|---|---|
| | | resistance |
| Materials | Pressure (MPa) | (mm² K W⁻¹) |
| Double-sided CNT/foil | 0.275 | 4 |
| Double-sided CNTs on Cu | 0.3 | 12 |
| Double-sided CNTs on foil | Independent of | 3.5 |
| | applied pressure | |
| Double-sided Tin NWs | 1 | 20 |
| Single sided Cu NWs on Cu | 5 | <5 |
| Single-sided CNTs | 0.069 | 1.7 |
| Double-sided Cu NWs on Cu | 5 | 2.5 |

Two commercial thermal pastes, JLJ TP133 (thermal conductivity: 13.3 W/(m-k)) and TOPDA T06 (thermal conductivity: 13.9 W/(m-k)) purchased from Amazon.com, Inc. were compared, which were the best thermal pastes with the highest thermal conductivity available. For JLJ TP133 thermal paste, the measured TCR dropped from 10.3 mm² K W⁻¹ to 6.4 mm² K W⁻¹ under pressures ranging from 1 MPa to 5 MPa. Similarly, for TOPDA 706 thermal paste, the measured TCR dropped from 9.7 mm² K W⁻¹ to 5.5 mm² K W⁻¹ within the same pressure range. Therefore, the double-sided Cu NWs exhibited superior performance compared to the tested commercial thermal pastes. Furthermore, commercial thermal pastes generally prove unsuitable for use at temperatures exceeding 200° C. In contrast, the double-sided Cu NWs offer additional benefits for high-temperature applications.

When the two meter bars are in direct contact without intermediate Cu, the measured contact resistance is solely from the interface between the meter bars, therefore, the measured resistance in case 1 can be expressed as:

$${R}_{m e asured , case 1} = {R}_{C u - C u} \qquad ( Eq . 6 )$$

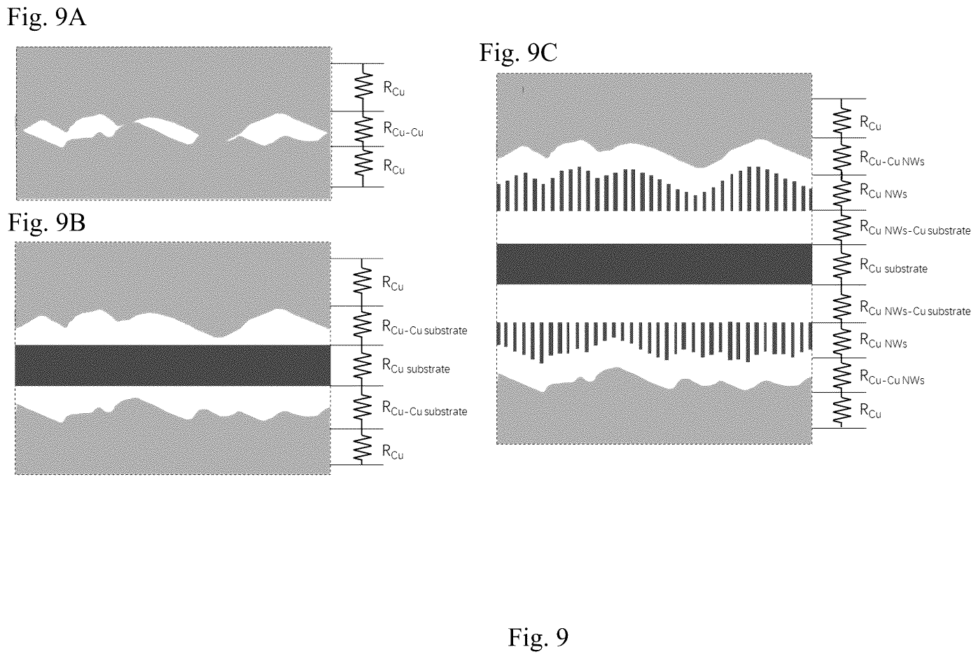

This is illustrated in FIG. 9A. When an intermediate Cu sheet without Cu NWs was added between the two meter bars, as shown in FIG. 9B, the measured total resistance was:

$${R}_{measured , case 2} = 2 \times {R}_{Cu - Cu substrate} + {R}_{Cu substrate} \qquad ( Eq . 7 )$$

where R_{Cu—Cu} sheet is the interface resistance between the Cu meter bar and the Cu sheet, and R_{Cu sheet} denotes the intrinsic bulk resistance of the Cu sheet:

$${R}_{Cu substrate} = \frac{t}{K} ,$$

(where t and K are the thickness and thermal conductivity of the Cu sheet, respectively). The Cu meter bar has a surface roughness of 0.68 m, while the Cu sheet has a smoother surface finish with a roughness of 0.38 μm. Therefore, it is expected that R_{Cu—Cu}>R_{Cu—Cu sheet}.

In case 3, when an intermediate Cu sheet with Cu NWs was used as a TIM between the two meter bars, as illustrated in FIG. 9C, the total resistance was measured as:

$${R}_{m e a s u r e d , c ase 3} = 2 \times {R}_{interface} + {R}_{TIM} = 2 \times {R}_{C u - Cu NWs} + {R}_{TIM} \qquad ( Eq . 8 )$$

where R_{interface} is the contact resistance between the Cu NWs and each adjacent surface, also expressed as R_{Cu—Cu NWs}. R_{TIM} is the intrinsic thermal resistance of the double-sided Cu NWs used as a TIM, which can be expressed as:

$${R}_{TIM} = 2 * {R}_{Cu NWs} + 2 \times {R}_{Cu NWs - Cu substrate} + {R}_{Cu substrate} \qquad ( Eq . 9 )$$

The parasitic resistances include the intrinsic resistance of Cu NWs (R_{Cu NWs}) and the Cu sheet (R_{Cu sheet}). The vertically aligned Cu NWs array minimizes the effective heat transfer path across the interface between the Cu sheet and the meter bars. Cu NWs were directly grown on both surfaces of the Cu sheet, providing chemical bonds between the base of individual NW and the growth sheet. As a result, the interface resistance between Cu NWs and Cu sheet (R_{Cu NWs-Cu sheet}) was negligible, and the equation simplified to:

$${R}_{TIM} = 2 * {R}_{Cu NWs} + {R}_{Cu sheet} \qquad ( Eq . 10 )$$

Thus, the total measured resistance for case 3 was:

$${R}_{m e asured , case 3} = 2 \times {R}_{interface} + 2 * {R}_{Cu NWs} + {R}_{Cu sheet} \qquad ( Eq . 11 )$$

This is a key advantage of using double-sided Cu NWs as a TIM compared to traditional one-sided nanostructures. Furthermore, R_{Cu NWs-Cu sheet} remained negligible under compression due to the strong bonding between Cu NWs and Cu sheet.

The vertically aligned Cu NWs array readily conforms to the adjacent surface roughness, changing the contact behavior between Cu NWs and the meter bars from point contacts to line contacts. This increased the real contact area between the meter bars and the tips of the Cu NWs, resulting in a significant reduction in the contact resistance between the meter bars and Cu NWs (R_{Cu—Cu Nws}), demonstrating great potential for TIMs application.

### Simulation Results

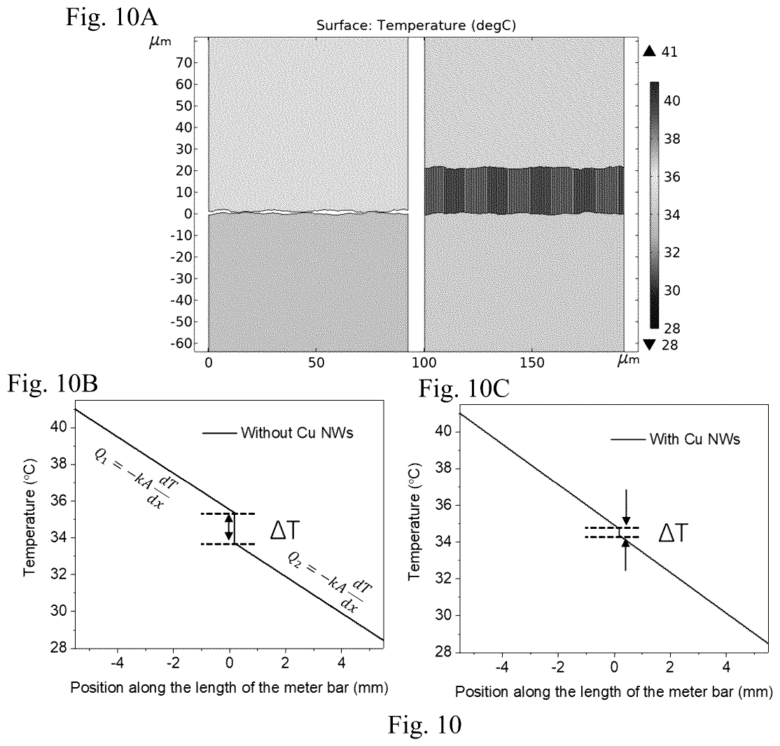

COMSOL Multiphysics simulation was performed to verify the experimentally measured results. The temperature distribution across the interface between the Cu meter bars with and without Cu NWs is presented in FIG. 10A. As shown, the temperature of the top meter bar and the bottom meter bar are distinct from each other. However, for the Cu meter bars connected with Cu NWs, the temperature across the interface almost shows the same color. The temperature profiles of the entire structure for the two cases are shown in FIG. 10B and FIG. 10C, respectively. As can be seen, the temperature difference across the interface (ΔT) was significantly reduced after Cu NWs were added between the two Cu meter bars. This indicates that the Cu NWs enhances the heat transfer across the interface. The TCR from the simulation was 42.21 mm² K W⁻¹ in case 1, when two Cu meter bars are in direct contact. When the Cu NWs array was placed between the two Cu meter bars, the TCR was 8.33 mm² K W⁻¹ according to the simulation. This verifies the excellent performance of Cu NWs as a TIM to enhance heat transfer.

### Electrical Contact Resistance (ECR)

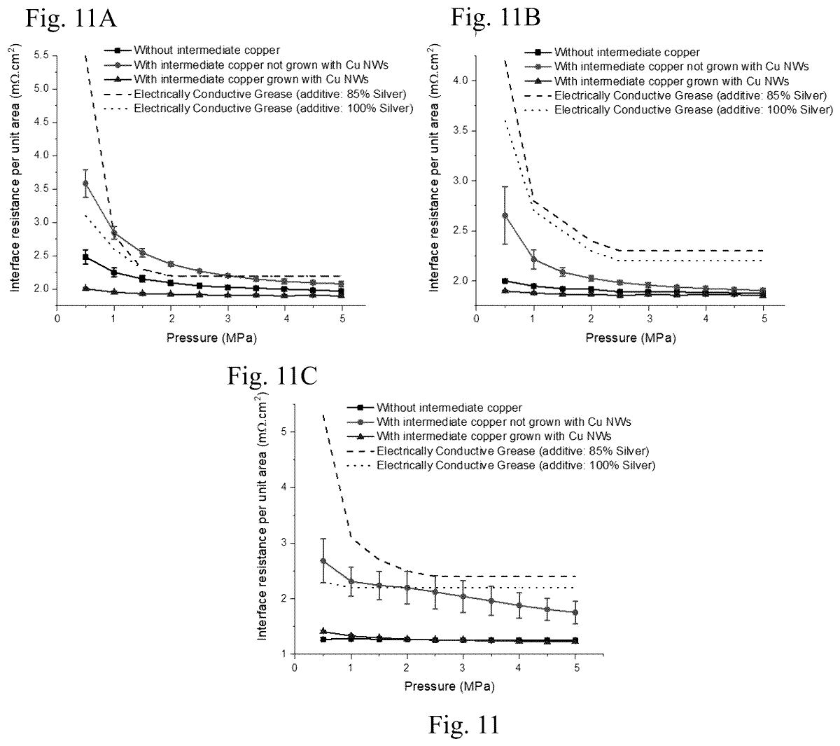

FIG. 11 compares the pressure-dependent contact resistance among three cases for three different mating pieces: (1) direct contact between the two mating Cu pieces without an intermediate Cu sheet, (2) with an intermediate Cu sheet (surface roughness: Sa=1.79 um) without Cu NWs, and (3) with an intermediate Cu sheet with Cu NWs. As observed, for as received Cu mating pieces (FIG. 11A), in all three cases, the ECR decreased as the pressure increased. In case 1, when no intermediate Cu was added between the Cu pieces, the interface resistance reduced from 2.49 mΩ·cm² to 1.97 mΩ·cm² with the pressure of 0.5 MPa to 5 MPa. In case 2, when adding intermediate Cu sheet without Cu NWs (red curve), the interface resistance reduced from 3.59 mΩ·cm² to 2.08 mΩ·cm² with the pressure of 0.5 MPa to 5 MPa. As expected, the contact resistance was the highest among the three cases due to the introduction of additional interface resistance between mating Cu pieces and intermediate Cu (R_{Cu—Cu intermediate}) and the bulk resistance of intermediate Cu (R_{Cu intermediate}). In contrast, in case 3, with the addition of an intermediate Cu sheet with Cu NWs on both sides, the ECR dropped from 2 mΩ·cm² to 1.9 mΩ·cm² as the pressure increased up to 5 MPa. Similar results were obtained for brushed Cu pieces as mating material. For both the as received and brushed mating surfaces (FIG. 11A and FIG. 11B), when adding the intermediate Cu sheet with Cu NWs, the resistance was the smallest and varied within the narrowest range (blue curves) among the three cases with the increase in pressure. This indicated that the implementation of double-sided Cu NWs can significantly reduce the ECR.

For the polished mating surfaces (FIG. 11C), when adding intermediate Cu sheet without Cu NWs remains the highest among three cases (red curve), with the ECR dropping from 2.68 mΩ·cm² to 1.75 mΩ·cm² in the measured pressure range of 5 MPa. However, when adding intermediate Cu grown with Cu NWs, the interface resistance reduced from 1.41 mΩ·cm² to 1.25 mΩ·cm² in the pressure range of 0.5 MPa to 5 MPa. This result is similar to that of case 1 when no intermediate Cu piece was added between two Cu blocks. This could be attributed to the fact that Cu NWs with a diameter of 0.4 μm and a filling ratio of 19% in the array may not enhance the contact behavior for very smooth polished mating surfaces. However, this could be improved by using Cu NWs with smaller diameter and higher density.

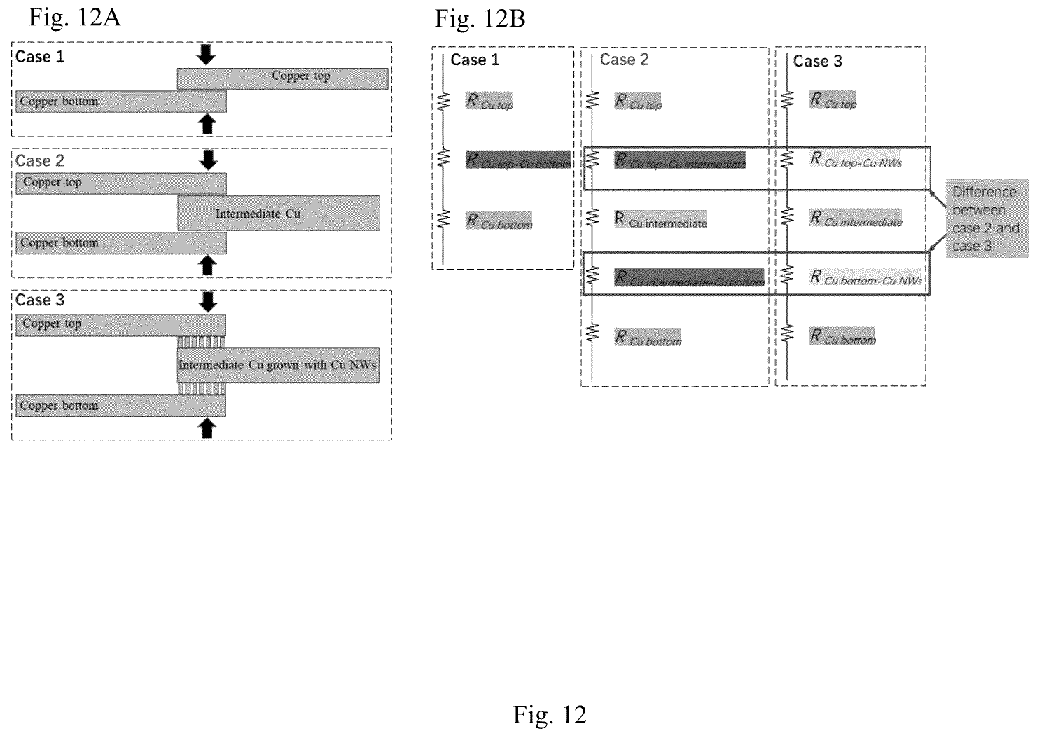

FIG. 12A and FIG. 12B illustrate the sample configuration for contact resistance measurement and electrical circuits, respectively, in the three cases. It should be noted that since the Cu NWs were directly grown on the intermediate Cu sheet, the interface resistance between them was ignored. Comparing case 3 with case 2, it can be concluded that Cu NWs dramatically reduced the contact resistance, as the only difference between case 3 and case 2 is the interface resistance between the mating Cu pieces and the intermediate Cu (R_{Cu—Cu intermediate}) and the interface resistance between the mating Cu pieces and the Cu NWs (R_{Cu—Cu NWs}) Two commercially available electrically conductive greases were compared with silicone thickener (part #: 1219K55, McMaster-Carr, Robbinsville, NJ, USA) and without thickener (part #: 1219K57, McMaster-Carr, Robbinsville, NJ, USA). These greases cannot be cured and remain in a paste-like state over time. This characteristic is suitable for applications where permanent bonding is not required, similar to the double-sided Cu NWs used as interfacial layers. As shown by the dashed lines in FIG. 11, for all the mating pieces, the ECR for both types of greases varies from 2.2 mΩ·cm² to 2.4 mΩ·cm² at a pressure of 5 MPa. Therefore, the performance of the double-sided Cu NWs is better than that of the two tested products for all three mating materials.

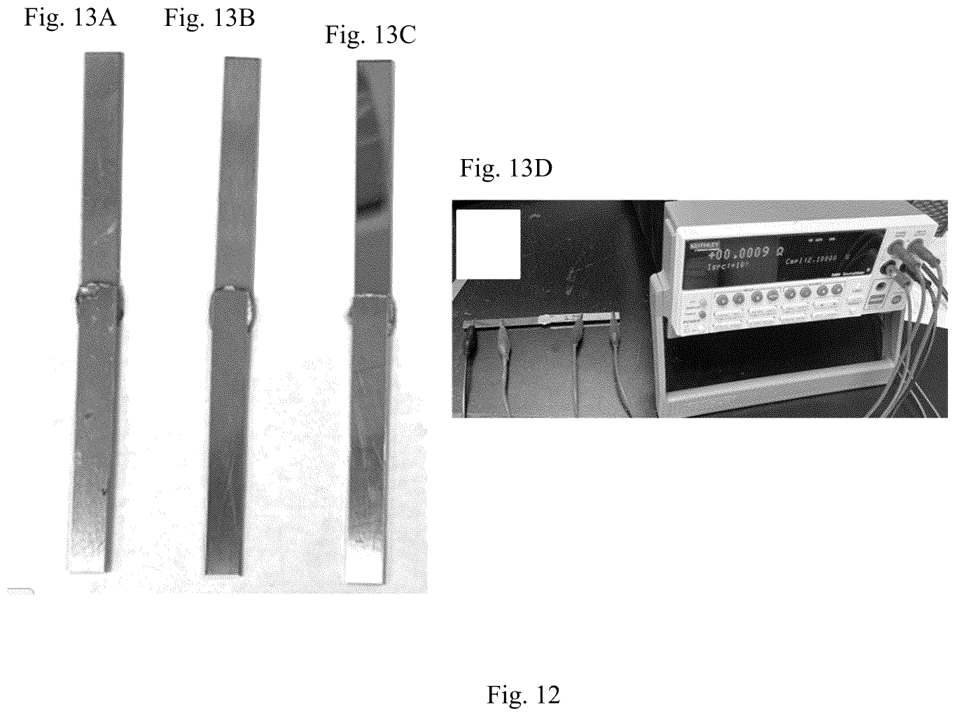

Two commercially available silver-based conductive epoxies used in electronics for permanent bonding were also compared, specifically Loctite® 3888 (volume resistivity <0.001 ohms-cm) and AA-DUCT 902 electrically conductive epoxy (volume resistivity <1×10⁻⁴ ohm·cm) (FIG. 13 and below, which depicts ECR of conductive epoxies for three different mating materials).

| Contact resistance (mΩ · cm) | As received | Brushed | Polished |
|---|---|---|---|
| Loctite ® 3888 surface filler | 0.9 | 0.8 | 0.9 |
| Electrically conductive epoxy | 1.6 | 1.6 | 1.7 |

After the products were applied to connect the metal pieces with different surface finishes and fully cured, the measured ECR for the Loctite® 3888 was 0.9 mΩ·cm². This result is better than that obtained from experimental samples. For AA-DUCT 902 electrically conductive epoxy, the measured ECR was 1.6 mΩ·cm², which is similar to the samples. However, the samples are advantageous in cases where permanent bonding of joints is not possible.

### Simulation Results

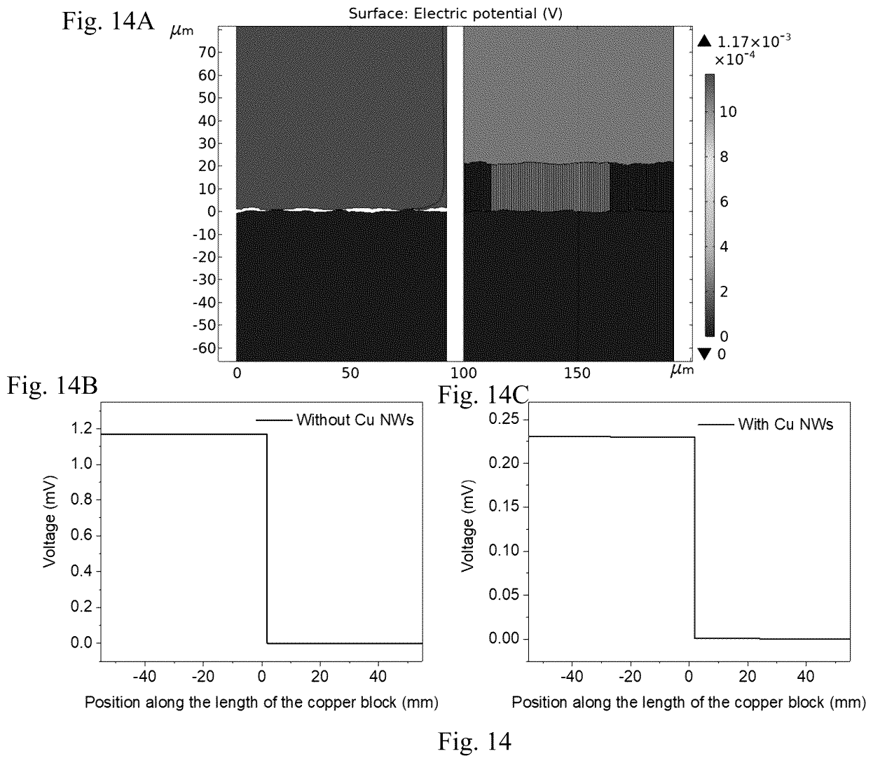

COMSOL Multiphysics simulations were conducted to verify the effect of Cu NWs as an electrical interconnect in reducing ECR. The results are shown in FIG. 14. The voltage distribution across the interface between the Cu blocks with and without Cu NWs is presented in FIG. 14A. As shown, a significant voltage difference was observed between the top Cu block and the bottom Cu block. However, for the Cu blocks connected with Cu NWs, the voltage across the interface shows less difference. This indicates that the Cu NWs enhance the electrical current transport across the interface. The voltage profiles of the entire structure for the two cases are shown in FIG. 14B and FIG. 14C, respectively. As can be seen, the voltage difference across the interface (ΔV) was dramatically decreased after Cu NWs were added between the two Cu blocks. The ECR for case 1 was 11.7 mΩ·cm²; when the Cu NWs array was placed between the two Cu blocks, the ECR was reduced to 2.3 mΩ·cm² according to the simulation. This verifies the excellent performance of Cu NWs as an electrical interconnect in reducing ECR.

In summary, the interface resistance measurement results demonstrated that double-sided Cu NWs have great potential to reduce and stabilize the contact resistance in electrical interconnection applications. The double-sided Cu NWs accommodated the surface roughness of the mating pieces in contact, increased the contact spots, and greatly improved the electrical current flow across the electrical joints.

In conclusion, a double-sided Cu NWs array was successfully prepared on a Cu sheet and utilized as a TIM to reduce TCR. The results demonstrated the effectiveness of double-sided Cu NWs in decreasing TCR as a TIM. Furthermore, the double-sided Cu NWs array was also employed as electrical interconnect to reduce ECR. The results demonstrated that double-sided Cu NWs are also effective in reducing ECR for electrical interconnection. These results were verified through COMSOL simulation. Moreover, the manufacturing processes of double-sided Cu NWs are scalable, and do not require expensive equipment or special conditions. Additionally, the reduction effect on TCR and ECR can be further enhanced by increasing the alignment and density of the Cu NWs in the array.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

We claim:

1. A method of making an interfacial material, comprising the steps of:
providing a double-sided substrate;
adhering a template to at least one side of the double-sided substrate to provide at least one templated side of the double-sided substrate;
exposing the double-sided substrate to a solution comprising a metal ion; and
reducing the metal ion to form a metal, thereby bonding the metal to the at least one templated side of the double-sided substrate in a controlled geometry.

2. The method of claim 1, wherein the metal is distributed on both sides of the double-sided substrate in a controlled geometry.

3. The method of claim 1, wherein the template comprises pores.

4. The method of claim 1, wherein the template comprises cylindrical pores.

5. The method of claim 1, wherein the template comprises pores having an average pore diameter of about 0.1 μm to about 1.0 μm.

6. The method of claim 1, wherein the solution comprising a metal ion comprises a copper ion.

7. The method of claim 1, wherein the solution comprising a metal ion comprises a metal precursor selected from copper sulfate, copper chloride, copper hydroxide, copper nitrate, copper oxide, copper acetate, copper fluoride, copper bromide, copper carbonate, or copper triflate.

8. The method of claim 1, wherein the solution comprising a metal ion comprises the metal ion in a concentration of at least 0.1 M.

9. The method of claim 1, wherein the step of reducing the metal ion comprising supplying the solution with a constant voltage.

10. The method of claim 1, further comprising the step of removing the template.

11. A material made using the method of claim 1.

12. A material comprising a double-sided substrate, wherein a metal is distributed on at least one side of the double-sided substrate in a wire array, wherein the wire array comprises a plurality of wires having an average diameter of about 0.1 μm to about 1.0 μm.

13. The material of claim 12, wherein the at least one metal is distributed on both sides of the double-sided substrate in a wire array.

14. The material of claim 12, wherein the double-sided substrate comprises copper.

15. The material of claim 12, wherein the double-sided substrate is flat.

16. The material of claim 12, wherein the metal is copper.

17. The material of claim 12, wherein the wire array is a nanowire array.

18. The material of claim 12, wherein the double-sided substrate has a thickness of 0.1 mm to 2.0 mm.

19. A device comprising the material of claim 12.

20. A device comprising a material comprising a double-sided substrate and a metal distributed on both sides of the double-sided substrate in a wire array, wherein the wire array comprises a plurality of wires having an average diameter of about 0.1 μm to about 1.0 μm.
